(19) United States
(12) Patent Application Publication
(10) Pub. No.: US 2020/0137862 A1
(43) Pub. Date: Apr. 30, 2020

(54) HIGH VOLTAGE GENERATING DEVICE AND X-RAY IMAGE DIAGNOSIS APPARATUS

(71) Applicant: HITACHI, LTD., Tokyo (JP)

(72) Inventors: Yuki KAWAGUCHI, Tokyo (JP); Shotaro SHINDO, Tokyo (JP); Satoru HATSUMI, Tokyo (JP); Mina OGAWA, Tokyo (JP)

(73) Assignee: HITACHI, LTD., Tokyo (JP)

(21) Appl. No.: 16/600,380

(22) Filed: Oct. 11, 2019

(30) Foreign Application Priority Data
Oct. 26, 2018 (JP) 2018-202190

(51) Int. Cl. H05G 1/12; H02M 3/335; H02M 1/08

(52) U.S. Cl. CPC H05G 1/12; H02M 2001/0009; H02M 1/08; H02M 3/33569

(57) ABSTRACT

A highly efficient high voltage generating device comprises a switching circuit 2 comprising plural switching elements S1˜S4 and connected with a direct current power source circuit 1, a rectifying circuit 4, a primary winding N1 connected with the switching circuit 2, a secondary winding N2 connected with the rectifying circuit 4 and a control circuit 5 to control the switching circuit 2. The control device 5 is configured to perform a current circulation function of passing a current to circulate between the switching circuit 2 and the transformer 3 to reverse polarity of a voltage VCp2 over the secondary winding N2, while keeping on at least one of the switching elements S1˜S4.

### CROSS REFERENCE TO RELATED APPLICATIONS

This application claims the foreign priority benefit under 35 U.S.C. § 119 of Japanese patent application No. 2018-202190, the disclosure of which is incorporated herein by reference.

### FIELD OF THE INVENTION

The present invention relates to a high voltage generating device and an X-ray image diagnosis apparatus.

### DESCRIPTION OF THE RELATED ART

The X-ray image diagnosis apparatus such as an X-ray CT apparatus and a general X-ray imaging apparatus receives an input from a general-purpose alternate current power source and applies as high a direct current voltage as several tens to 100 kV to an X-ray tube that is a load. One example of a high voltage generating device used for this kind of the apparatus is an invention of claim 1 of Japanese Patent Application Publication No. H02-242597A (referred to as H02-242597A hereinafter) that describes “An inverter type X-ray apparatus comprising an inverter that receives a direct current voltage as an input and coverts the direct current voltage to an output voltage of an alternate current voltage, a high voltage transformer configured to boost the output voltage of the inverter, a rectifier configured to rectify an output voltage of the high voltage transformer, an X-ray tube to which an output voltage of the rectifier is applied, wherein there is a gap formed between leg portions of an iron core of the high voltage transformer.

Looking at H2-242597A, the X-ray image diagnosis apparatus as described in H2-242597A requires a high voltage generating device that is capable of being used for a wide range of loads to alter a voltage applied to an X-ray tube (referred to as “tube voltage” hereinafter) and a current passing through the X-ray tube (referred to as “tube current” hereinafter) depending on how large a body size a person to be examined has and what portion of the body is to be imaged. In addition, the X-ray image diagnosis apparatus has to be capable of operating in such a way as to supply a high tube for a relatively short imaging time for a high load and a small current for a and a long continuous time for a low load. Therefore, the X-ray image diagnosis apparatus needs to have a high power conversion efficiency over a wide range of the load conditions. PWM control is widely known for a control method for a high frequency inverter to be fit for the wide range of load conditions. In the case of PWM control, its output control over the wide range of the load condition is enabled by changing a duty ratio, which corresponds to a on period ratio during the switching period of each of switching elements, of which each pair of diagonally positioned ones are simultaneously switched on and off.

Since the high voltage generating device used for the X-ray image diagnosis apparatus has a turn ratio of a transformer that is larger than the general power source, the stray capacitance generated at the secondary side of the transformer is so large as cannot be ignored. Therefore, in the case of this high voltage generating device, the large stray capacitance can be used for a resonance element to obtain a voltage increase ratio (output voltage divided by voltage of DC power source) that is equal to or larger than the turn ratio of the transformer, which leads to the size of the transformer becoming smaller. However, when the tube voltage is low, the peak current of the high frequency inverter becomes high due to the voltage boosting effect resulting from the stray capacitance and a breaking current generated when each switching element is switched off becomes high. As a result, the switching loss of the switching element becomes so large that it is difficult to make the high voltage generating device highly efficient, which is a problem for the high voltage generating device. In addition, if the stray capacitance is high, since a voltage on the stray capacitance is applied to the transformer even when all the switching elements are switched off, it seems that an intermittent control can be applied, in which an off period when all the switching elements are switched off is varied. However, in this case, there would be a problem with magnetic saturation of the transformer. Since a short circuit current from a power source to the transformer is induced when the transformer becomes in a magnetic saturation state, it becomes difficult to make the high voltage generating device more efficient due to the circuit loss resulting from the short circuited current.

### SUMMARY OF THE INVENTION

Taking the above background technology into account, the present invention has been created and is intended to provide a highly efficient high voltage generating device and an X-ray image diagnosis apparatus.

A high voltage generating device to achieve the objective above described comprises a switching circuit comprising plural switching elements and connected with a direct current power source, a rectifying circuit, a transformer comprising a primary winding connected with the switching circuit and a secondary winding connected with the rectifying circuit and a control device controlling the switching circuit, the control device configured to control the switching circuit in such a way that a current passes to circulate between the switching circuit and the transformer so as to reverse polarity of a voltage over the secondary winding, while keeping on at least one of the plural switching elements.

According to the present invention, a highly efficient high voltage generating device is realized.

### BRIEF DESCRIPTION OF THE DRAWINGS

FIG. 1 is a circuit diagram representing a circuit of a high voltage generating device of a first embodiment of the present invention.

FIGS. 2A to 2C are diagrams explaining how a high voltage generating device of a first comparison example works.

FIGS. 3A and 3B are diagrams further explaining how the high voltage generating device of the first comparison example works.

FIGS. 4A and 4B show equivalent circuits of a key part of the first comparison example.

FIGS. 5A to 5J show waveforms at various parts of the first comparison examples.

FIG. 6 is a flowchart of a control program for the first embodiment.

FIGS. 7A to 7D are diagrams explaining how a low voltage mode of the first embodiment works.

FIGS. 8A to 8D are diagrams further explaining how the low voltage mode of the first embodiment works.

FIGS. 9A to 9J show waveforms representing operations of various parts in the low voltage mode of the first embodiment.

FIG. 10 is a circuit diagram representing a circuit of an X-ray image diagnosis apparatus of a second embodiment.

FIG. 11A to 11D are diagrams explaining how the second embodiment works.

FIGS. 12A to 12D are diagrams further explaining how the second embodiment works.

FIGS. 13A to 13K show waveforms representing operations of various parts of the second embodiment.

FIGS. 14A to 14D are diagrams explaining how a second comparison example works.

FIGS. 15A to 15D are diagrams further explaining how the second comparison example works.

FIGS. 16A and 16B are diagrams further explaining how the second comparison example works.

FIGS. 17A to 17K show waveforms representing operations of various parts of the second comparison example.

FIG. 18 is a flowchart of a control program for a third embodiment.

FIGS. 19A to 19D are diagrams explaining how the third embodiment works.

FIGS. 20A to 20D are diagrams further explaining how the third embodiment works.

FIGS. 21A to 21C are diagrams further explaining how the third embodiment works.

FIGS. 22A to 22J show waveforms representing operations of various parts of the third embodiment.

FIGS. 23A to 23J show other waveforms representing operations of various parts of the third embodiment.

### DETAILED DESCRIPTION OF THE INVENTION

### First Embodiment

<Configuration of First Embodiment>

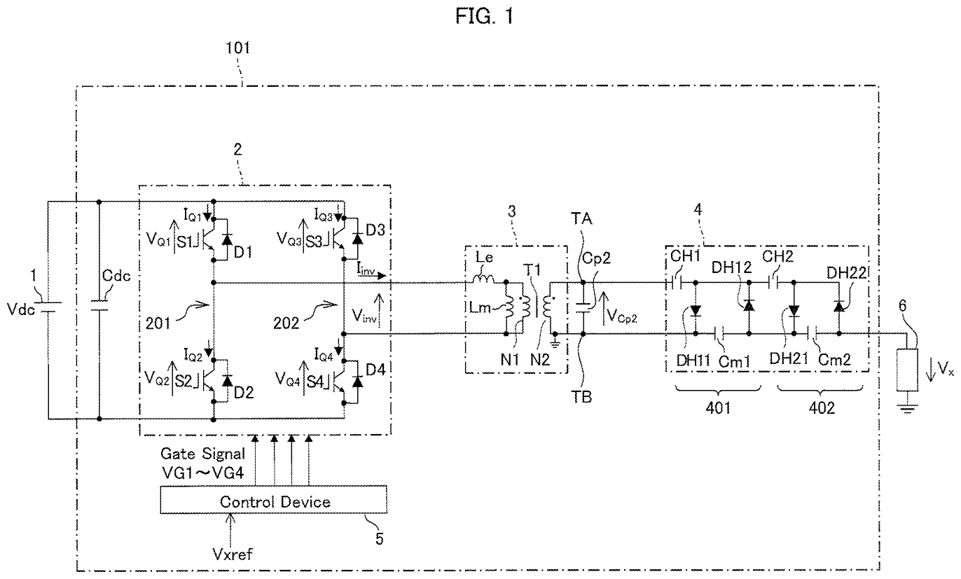

FIG. 1 is a circuit configuration figure representing a circuit of a high voltage generating device 101 of a first embodiment of the present invention.

The high voltage generating device 101 comprises a smoothing capacitor Cdc, a high frequency inverter 2, a transformer 3, a resonant capacitor Cp2, a rectifying circuit 4 and a control device 5 and is intended to transform an output voltage (referred to as power source voltage Vdc hereinafter) of a direct current power source 1 to any direct current voltage and apply it to a load device 6. Hereinafter, the direct current voltage applied to the load device 6 is referred to as an output voltage Vx. The resonant capacitor Cp2 is connected to a secondary winding N2 of the transformer 3. A stray capacitance, which exists between terminals of the secondary winding of the transformer 3 or between elements of the rectifying circuit 4 and the ground, may be used as an alternative to the resonant capacitor Cp2.

The high frequency inverter 2 is configured to modulate the direct current voltage input from the direct current power source 1 and output an alternate current voltage of any frequency and comprises a first leg 201 and a second leg 202. The first leg 201 comprises switching elements S1 and S2 which are connected in series and diodes D1 and D2 which are connected respectively in parallel with the switching elements S1 and S2. Similarly, the second leg 202 comprises switching elements S3 and S4 which are connected in series and diodes D3 and D4 which are connected respectively in parallel with the switching elements S3 and S4. Though the example as shown in FIG. 1 uses IGBT (Insulated Gate Bipolar Transistor) for the switching elements S1 to S4, other semiconductor elements such as MOS-FET (Metal-Oxide-Semiconductor Field-Effect Transmitter) may be used as an alternative.

The transformer 3 is configured to transform an alternate current voltage supplied from the high frequency inverter 2 to any alternate current voltage and apply the transformed voltage to the rectifying circuit 4 and comprises a primary winding N1, a magnetic material core T1 and a secondary winding N2. The transformer 3 has a boosting inductor Le that corresponds to a leakage inductance of the primary winding N1 and an excitation inductance Lm. In case the leakage inductance of the primary winding N1 is not sufficiently high, an individual inductor may be connected for the boosting inductor Le.

The rectifying circuit 4 is configured to rectify and smooth the alternate current voltage supplied from the secondary winding N2 of the transformer 3 and output the rectified and smoothed voltage to the load device 6 and comprises voltage multiplier circuits 401 and 402, each of which is a Cockcroft-Walton circuit. The voltage multiplier circuit 401 comprises a rectifying capacitor CH1, diodes DH11, DH12 and a smoothing capacitor Cm1. The voltage multiplier circuit 402 comprises a rectifying capacitor CH2, diodes DH21, DH22 and a smoothing capacitor Cm2.

The control device 5 comprises hardware devices such as CPU (Central Processing Unit), DSP (Digital Signal Processor), RAM (Random Access Memory) and ROM (Read Only Memory), which a general-purpose computer has. ROM stores a control program to be executed by CPU, a micro-program to be executed by DSP and various data are stored in ROM. Control programs to be executed by CPU or other devices are detailed below.

The control device 5 is configured to receive from a superordinate device an output voltage instruction value Vxref which is an instruction value for an output voltage Vx. Then the control device 5 is configured to output gate signals VG1 to VG4 to switch on or off the switching elements S1 to S4 in such a way that the output voltage Vx becomes closer to the output voltage instruction value Vxref.

### First Comparison Example

Before explaining how the embodiment of the present invention works, a configuration and an operation of a first comparison example are to be explained. To begin with, a high voltage generating device of the first comparison example has the same circuit configuration as that of the first embodiment (See FIG. 1) as described above.

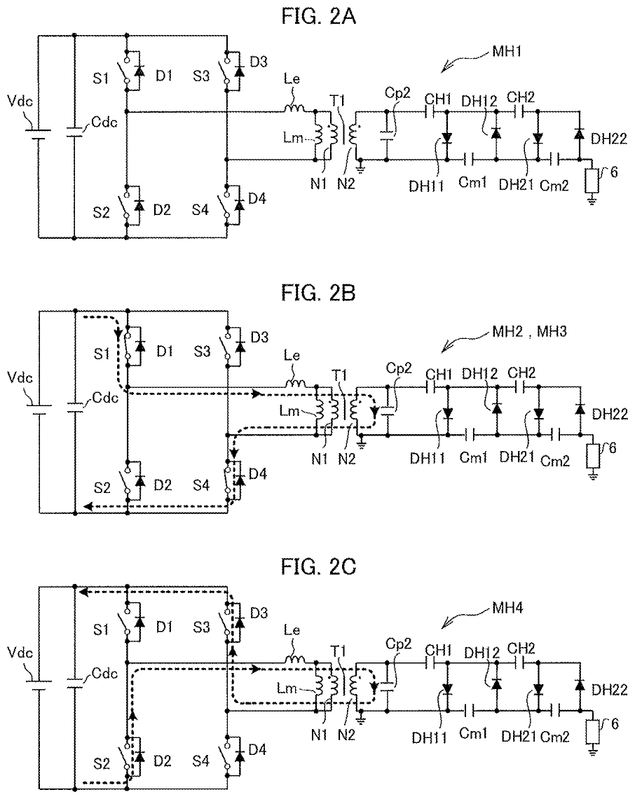

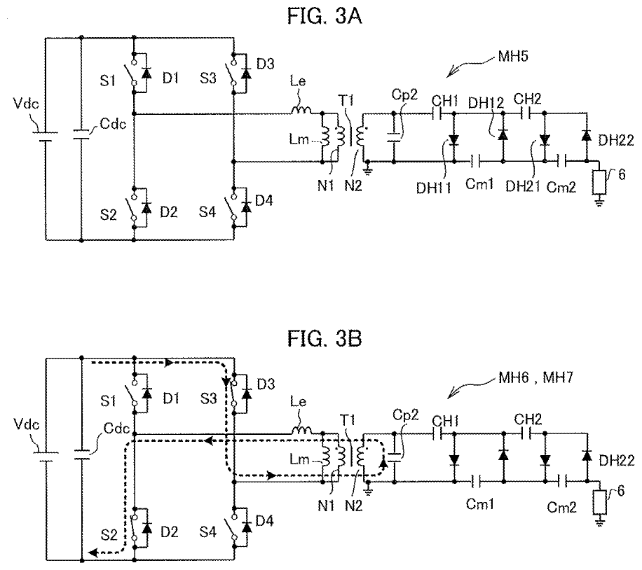

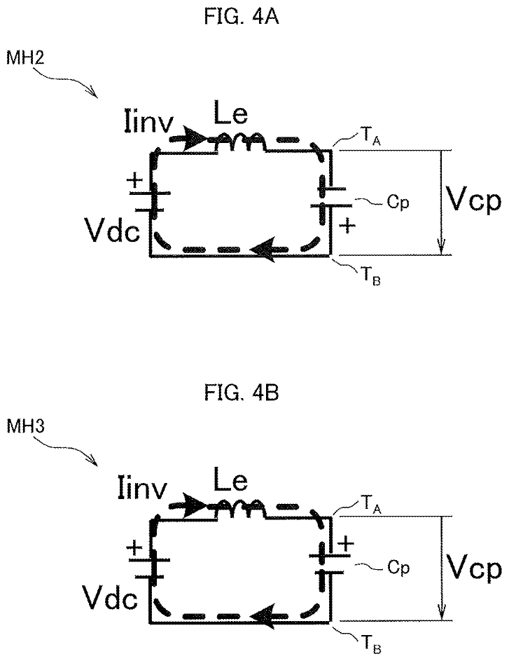

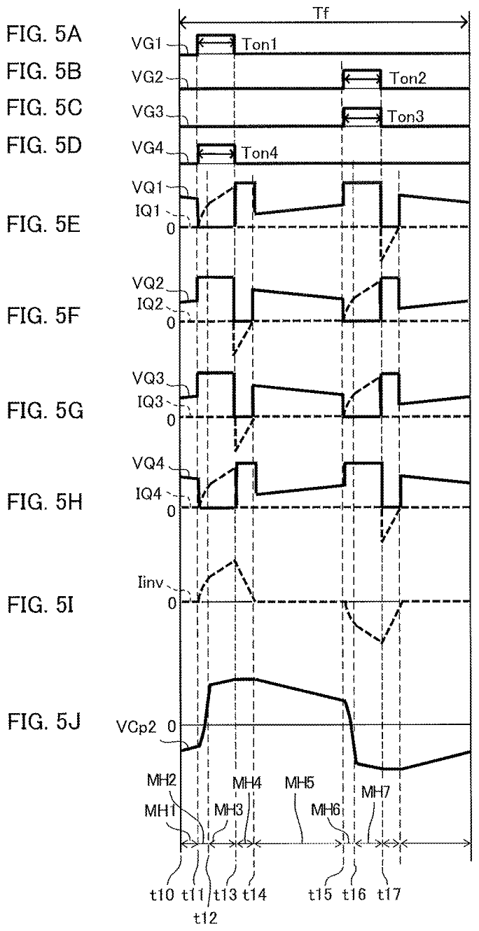

FIGS. 2A to 2C show states, MH1 to MH4, of the high voltage generating device of this comparison example. FIGS. 3A, 3B show other states, MH5 to MH7, of the same device. FIGS. 4A, 4B show equivalent circuits of a key part in the states MH2, MH3. FIGS. 5A to 5J show waveforms of various parts of the comparison example. In FIG. 5, voltages VQ1 to VQ4 indicate respectively terminal voltages of the switching elements S1 to S4 and currents IQ1 to IQ4 indicate respectively currents passing through parallel circuits consisting of the switching elements S1 to S4 and the diodes D1 to D4.

In FIGS. 2A to 2C and FIGS. 3A, 3B, a symbol of each of the switching elements indicates whether the switching element is on or off. An arrow of each broken line indicates a path along which an inverter current Iinv passes. FIGS. 2A to 2C and FIGS. 3A, 3B mainly indicate on or off states of the switching elements S1 to S4 and paths along which the inverter current Iinv passes and skip symbols of part of the elements. Some signs indicated in FIG. 1 are skipped in FIGS. 2A to 2C and FIGS. 3A, 3B. The operation of the rectifying circuit 4 is the same as those of well-known technologies and not detailed.

(State MH1: t10˜t11)

The switching elements S1 to S4 in the state MH1 in FIG. 2A are off and no current passes through the high frequency inverter 2. The state MH1 corresponds to states between Time t10 and Time t11 in FIGS. 5A to 5J. In the state MH1, the resonant capacitor Cp2 is charged with a terminal TB of the secondary winding N2 being on the positive side. Accordingly, a capacitor voltage VCp2 has a negative value in the state MH1 (See FIG. 5J). The state MH1 transitions to a state MH2 on switching on the switching elements S1, S4 in the state MH1.

(State MH2: t11˜t12)

As shown in FIGS. 5A to 5D, periods during which gate signals VG1 to VG4 are at a high level, i.e. periods during which the switching elements S1 to S4 are kept on, are referred to respectively as on-periods Ton1 to Ton 4. In this comparison example, the switching elements S1 and S4 are paired while the switching elements S2 and S3 are paired. PWM control is carried out with each pair of the two switching elements kept on. In addition, the on-periods Ton1 to Ton4 are identical to one another in this comparison example and a duty ratio DT of the high frequency inverter 2 (See FIG. 1) is represented as follows.

DT=(2×Ton1)/Tf=(2×Ton3)/Tf Equation 1

Tf is a switching cycle in Equation 1.

As shown in FIG. 2B, since the switching elements S1 and S4 are kept on in the state MH2, an inverter current Iinv passes through a path through the switching element S1, the boosting inductor Le, the resonant capacitor Cp2 and the switching element S4 in the primary side of the transformer 3. During a period of the state MH2, the inverter current Iinv passing through the high frequency inverter 2 is represented as follows.

Iinv=(Vdc+VCp)×Δt/(ωLe) Equation 2

In Equation 2, ω denotes a switching frequency that is equal to (2π/Tf). VCp is a voltage to which the capacitor voltage VCp2 applied to both terminals of the resonant capacitor Cp2 is primary-side-converted and referred to as a primary-side-converted capacitor voltage hereinafter. Suppose P denotes a boosting ratio of the transformer, VCp=VCp2/P applies. The boosting ratio P is more or less equal to a winding ratio between the primary winding N1 and the secondary winding N2. Δt is a time that elapses after Time t11 when the transition to the state MH2 takes place. When the state MH2 gets started from the state MH1, the resonant capacitor Cp2 is still charged with the terminal TB being on the positive side.

Cp in the equivalent circuits in FIGS. 4A and 4B is what the resonant capacitor Cp2 is primary-side-converted to and is referred to as a primary-side-converted resonant capacitor Cp. A capacitance of the primary-side-converted capacitor Cp is equal to a capacitance of the resonant capacitor Cp2 multiplied by a square of the boosting ratio P. Since the primary-side-converted capacitor voltage VCp has a negative value in the state MH2 in FIG. 4, a voltage that is equal to |Vdc|+|VCp| is applied to the boosting inductor Le. As a result, the inverter current Iinv increases sharply as compared with the case where there is no resonant capacitor Cp2. During the period of the state MH2, the resonant capacitor Cp2 is discharged once and energy is stored in the boosting inductor Le. Then the resonant capacitor Cp2 is charged with a terminal TA being on the positive side. On the capacitor voltage VCp reaching the output voltage Vx, the state MH2 transitions to a state MH3.

(State MH3: t12˜t13)

As shown in FIG. 2B, the switching elements S1 and S4 remain unchanged from the state MH2 and are kept on in the state MH3. Accordingly, the inverter current Iinv passes through a path through the switching element S1, the boosting inductor Le, the resonant capacitor Cp2 and the switching element S4 in the primary side of the transformer 3. During a period of the state MH3, the inverter current Iinv passing through the high frequency inverter 2 is represented more or less by Equation 2 above mentioned. However, as shown in FIG. 4B, the primary-side-converted resonant capacitor Cp is charged with the terminal TA being on the positive side.

Accordingly, a voltage equal to |Vdc|−|VCp| is applied to the boosting inductor Le. Therefore, as shown in FIG. 5I, a slope of the inverter current Iinv during the period of the state MH3 is more gradual than during the period of the state MH2. Then the state MH3 transitions to a state MH4 on switching off the switching elements S1 and S in the state MH3.

(State MH4: t13˜t14)

As shown in FIG. 2C, the inverter current Iinv passes through a path through the diode D2, the boosting inductor Le and the resonant capacitor Cp2 to the diode D3. As a result, the energy stored in the boosting inductor Le is transferred to the resonant capacitor Cp2 and the smoothing capacitor Cdc at the power source side is regenerated. When the energy stored in the boosting inductor becomes zero, the state MH4 transitions to a state MH5.

(State MH5: t14˜t15)

As shown in FIG. 3A, the switching elements S1 to S4 remain unchanged from the state MH4 and are kept off in the state MH5 with no current passing through the boosting inductor Le. During a period of the state MH5, the resonant capacitor Cp2 is charged with the terminal TA (See FIG. 1) of the secondary winding N2 being on the positive side. The state MH5 transitions to a state MH6 on switching on the switching elements S2 and S3 when the high voltage generating device 101 is in the state MH5.

(States MH6, MH7: t15˜t17)

When the high voltage generating device is in the states MH6 and MH7, symmetrical operations to those occurring in the states MH2 and MH3 occur. Accordingly, as shown in FIG. 3B, the inverter current passes through a path through the switching element S3, the resonant capacitor Cp2, the boosting inductor Le and the switching element S2. Then, when the control device 5 switches off the switching elements S2 and S3 simultaneously, symmetrical operations to those occurring in the states MH4 and MH5 occur.

In the case of the comparison example in the steady state, operations in the states MH1˜MH7 as described above and their symmetrical operations are repeated as default operations. Accordingly, when the high voltage generating device of the comparison example is in the state MH2 (See FIG. 2B and FIG. 4A), there is a period when the inverter current Iinv increases sharply because of utilization of a voltage boosting effect of the resonant capacitor Cp2. When the output voltage Vx is high, the primary-side-converted capacitor voltage VCp in the state MH3 is higher than the power source voltage Vdc and “the power source voltage Vdc<the primary-side-converted capacitor voltage VCp” applies. Therefore, the slope of the inverter current Iinv becomes negative. As a result, it is possible to reduce a breaking current generated when the switching elements S1 and S4 are turned off.

However, when the output voltage Vx is low, “the power source voltage Vdc>the primary-side-converted capacitor voltage VCp” applies in the state MH3. Then, like the waveform of the inverter current Iinv between Time t12˜Time t13, the slope of the inverter current Iinv becomes positive and the inverter current Iinv becomes higher. As a result, the breaking current is higher when the switching elements S1 and S4 are turned off at Time t13.

As explained above, since the high voltage generating device 101 of the comparison example has a high peak of the inverter current due to the voltage boosting effect of the resonant capacitor Cp2, the high voltage generating device of the comparison example has a problem with a switching loss being larger when the output voltage Vx is low than when the output voltage Vx is high.

(Total Operation of First Embodiment)

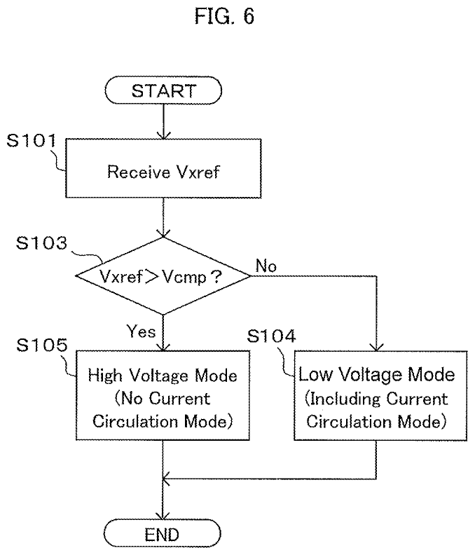

Next, the total operation of the first embodiment is explained. FIG. 6 is a flowchart of a control program to be executed by the control device 5 of the first embodiment.

When the processing in FIG. 6 gets started, the control device 5 receives from a superordinate device (not shown) an output voltage instruction value Vxref that is an instruction value for the output voltage Vx in Step S101. Next, the processing goes to Step S102 and the control device 5 determines whether the output voltage instruction value Vxref is higher than a predetermined threshold value Vcmp or not. If determined to be “YES”, the processing goes to Step S105 to select a high voltage mode for the operation mode. On the other hand, if determined to be “NO”, the processing goes to Step S104 to select a low voltage mode for the operation mode. When either Step S104 or Step 105 is finished, the processing of the program ends.

(Operation in High Voltage Mode)

The operation of the high voltage generating device 101 in the high voltage mode that is selected in Step S105 is more or less the same as the operation of the comparison example as described above (See FIG. 2A˜FIG. 5).

When the high voltage mode is selected in this embodiment, the output voltage Vx (or the voltage instruction value Vxref) is so high that the waveform of the inverter current Iinv in the state MH3 is different from that indicated in FIG. 5. Since the slope of the inverter current Iinv is negative in the state MH3 (between Time t12˜Time t13), the inverter current Iinv is sufficiently low at Time t13. As a result, the breaking current generated at Time t13 when the switching elements S1 and S4 are turned off is low, which results in the switching loss being small.

(Operation in Low Voltage Mode)

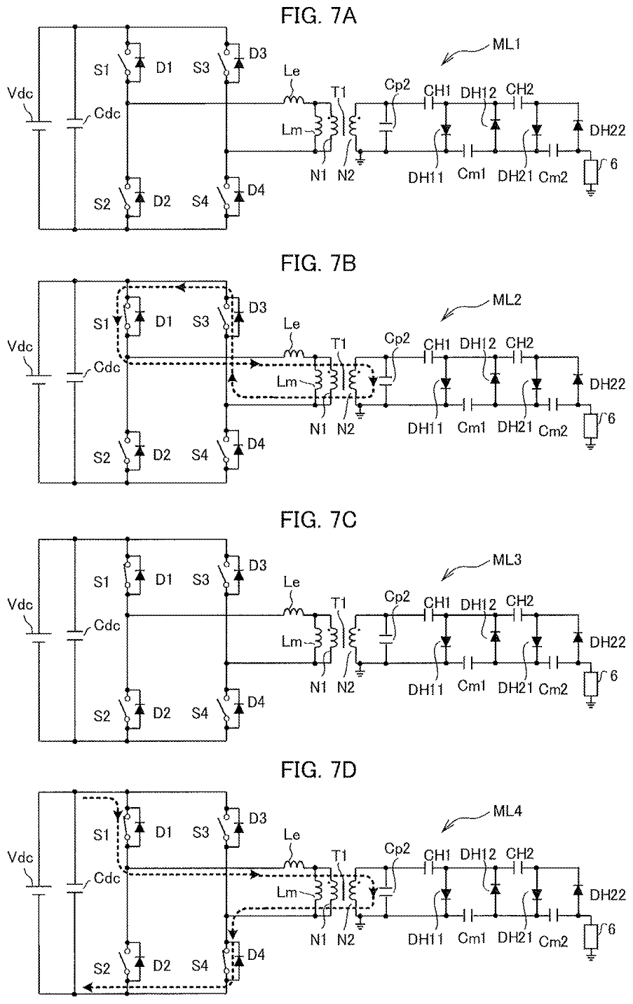

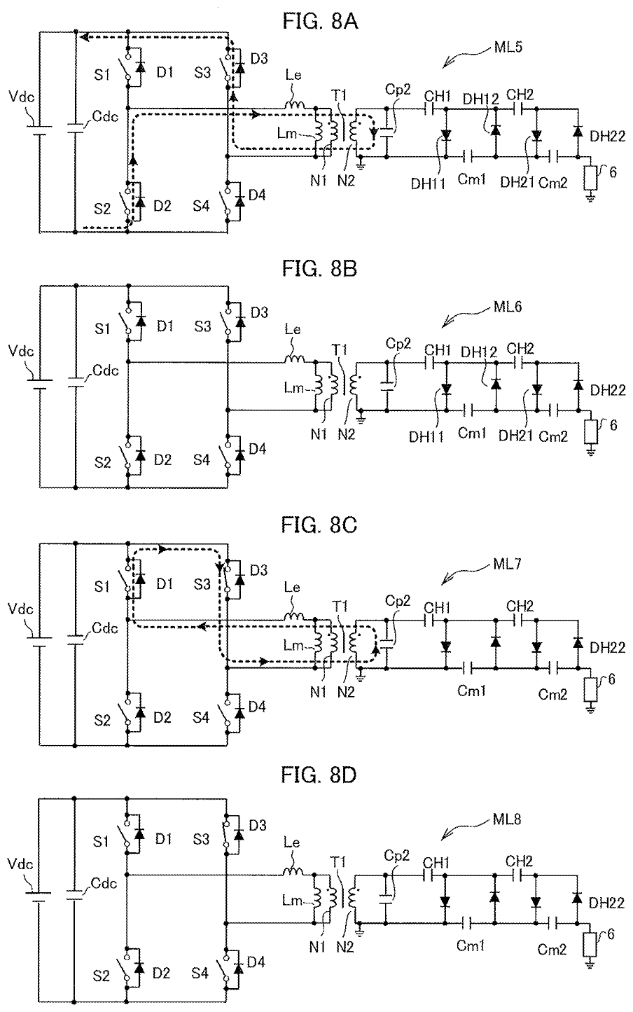

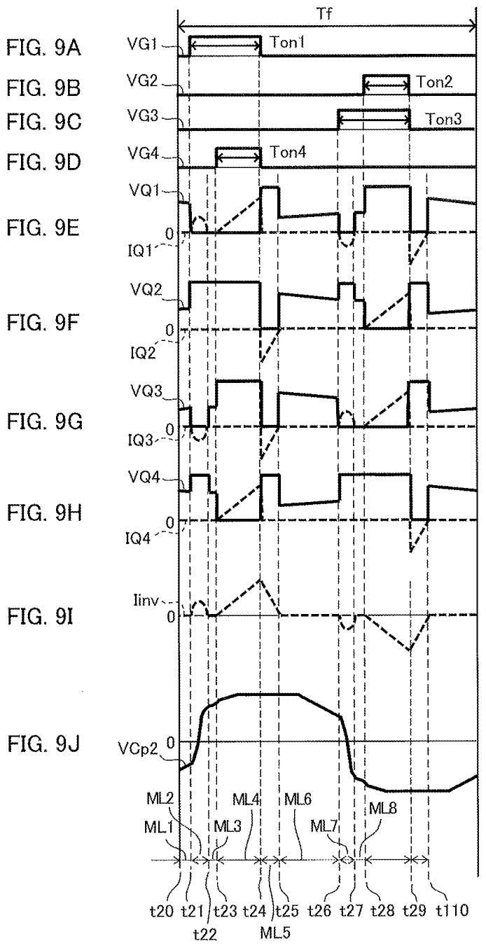

FIGS. 7A to 7D and FIGS. 8A to 8D explain how the high voltage generating device 101 of the first embodiment operates in each state of the low voltage mode. FIGS. 9A to 9J show waveforms of the various parts in the low voltage mode.

(State ML1: t20˜t21)

The switching elements S1 to S4 are off in the state ML1 in FIG. 7A and no current passes through the high frequency inverter 2. This state ML1 corresponds to a period between Time t20 and Time t21. The resonant capacitor Cp2 (See FIG. 1) is charged with the terminal TB of the secondary winding N2 being on the positive side in the state ML1. The state ML1 transitions to a state MH2 when the switching element S1 is switched on in the state ML1.

(State ML2: t21˜t22)

Only the switching element S1 is on in the state ML2 and the inverter current Iinv passes from the resonant capacitor Cp2 that works as a power source through a path through the diode D3, the switching element S1 and the boosting inductor Le and circulates through this path, as indicated in FIG. 7A. A state in which a current passing through the boosting inductor Le circulates is referred to as “current circulation mode”. As this circulating inverter current Iinv is passing, the resonant capacitor Cp2 charged with the terminal TB of the secondary winding N2 being on the positive side discharges all electrical charges it stores.

Subsequently, the resonant capacitor Cp2 is charged again with the terminal TA of the secondary winding N2 being on the positive side. Accordingly, as the waveform of the capacitor voltage VCp2 during a period from Time t21 to t22 in FIG. 9J indicates, polarity of the capacitor voltage VCp2 reverses from negative to positive during this period. The state ML2 transitions to a state ML3 when the inverter current Iinv passing through the high frequency inverter 2 becomes zero.

(State ML3: t22˜t23)

The inverter current Iinv is zero with the switching element S1 kept on in the state ML3. The resonant capacitor Cp2 is charged with the terminal TA of the secondary winding N2 being on the positive side. Accordingly, as shown in FIG. 9J, the capacitor voltage VCp2 becomes positive in the state ML3 (Time t22˜Time t23). The state ML3 transitions to a state ML4 on switching on the switching element S4.

(State ML4: t23˜t24)

The switching elements S1 and S4 are on in the state ML4 as shown in FIG. 7D, and the inverter current Iinv passes through a path through the switching element S1, the boosting inductor Le, the resonant capacitor Cp2 and the switching element S4. This state ML4 corresponds to the state MH3 in the high voltage mode (or in the comparison example) and the inverter current Iinv is calculated from Equation 2 as explained above. Like the state MH3 in FIG. 4B, a differential between the power source voltage Vdc and the primary-side-converted capacitor voltage VCp is applied to the boosting inductor Le. Therefore, the slope of the inverter current Iinv is more gradual than when only the power source voltage Vdc is applied to the boosting inductor Le. The state ML4 transitions to a state ML5 on switching off the switching elements S1 and S4.

(State ML5: t24˜t25)

The switching elements S1 to S4 are off in the state ML5 as shown in FIG. 8A and the inverter current Iinv passes through a path through the diode D2, the boosting inductor Le, the resonant capacitor Cp2 and the diode D3. Due to this inverter current passing, energy stored in the boosting inductor Le is transferred to the resonant capacitor Cp2 and the smoothing capacitor Cdc. The state ML5 transitions to a state ML6 when the energy stored in the boosting inductor Le is completely discharged.

(State ML6: t25˜t26)

The switching elements S1 to S4 are off in the state ML6 as shown in FIG. 8B and no current passes through the high frequency inverter 2. In addition, since the resonant capacitor Cp2 is charged with the terminal TA of the secondary winding N2 being on the positive side in the state ML6, the capacitor voltage VCp2 has a positive value, as indicated in FIG. 9J. The state ML6 transitions to a state ML7 on switching on the switching elements S2 and S3.

(State ML7: t26˜t27)

Only the switching element S3 is on in the state ML7 as shown in FIG. 8C. In the state ML7, an operation in the current circulation mode occurs and the inverter current Iinv passes from the resonant capacitor Cp2 that works as a power source through a path through the boosting inductor Le, the diode D1 and the switching element S3 and circulates through this path, as indicated in FIG. 8C. In this operation, the resonant capacitor Cp2 charged with the terminal TA of the secondary winding N2 being on the positive side discharges all electrical charges it stores. Subsequently, the resonant capacitor Cp2 is charged again with the terminal TB of the secondary winding N2 being on the positive side. Accordingly, as the waveform of the capacitor voltage VCp2 during a period from Time t25 to Time t26 indicated in FIG. 9J, polarity of the capacitor voltage VCp2 reverses from positive to negative during this period. The state ML7 transitions to a state ML8 when the inverter current passing through the high frequency inverter 2 becomes zero.

(State ML8: t27˜t28)

In the state ML8, the inverter current Iinv passing through the high frequency inverter 2 is zero with only the switching element 3 kept on. Since the resonant capacitor Cp2 is charged with terminal TB of the secondary winding N2 being on the positive side in this state, the capacitor voltage VCp2 is negative, as indicated in FIG. 9J.

(After Time t28)

When the switching element S2 is switched on in the state ML8, a symmetrical operation to the operation occurring in the state ML4 occurs during a period from Time t28 to Time t29. Then the switching elements S2 and S3 are switched off and a symmetrical operation to the operation occurring in the state ML5 occurs during a period from Time t29 to Time t110.

After these operations above described, the operations in the states ML1˜ML8 or their symmetrical operations are repeated as default operations.

It should be noted that if the switching element S4 or S2 is switched on before the inverter current Iinv passing through the high frequency inverter 2 becomes zero in the state ML2 or ML7 as explained above, the switching loss resulting from a recovery operation of the diode D3 or D1 becomes larger. There is a risk that the switching loss is so large that there are elements broken. Therefore, it is preferable to determine when each of the switching elements S4 or S2 is switched on, taking into account the period of the current circulation mode (in the states ML2 and ML7) in advance.

(Effect of First Embodiment)

As explained above, the first embodiment has a current circulation function (in the states ML2 and ML7) to reverse the polarity of the resonant capacitor voltage VCp2 over the resonant capacitor Cp2 when the output voltage Vx is low. This function prevents the slope of the inverter current Iinv becoming steep (for example, the state MH2 as indicated in FIG. 2B, FIG. 4A and FIG. 50, which occurs in the first comparison example. Due to this effect, the peak current of the high frequency inverter 2 is prevented from becoming high when the output voltage is low.

If the peak current is prevented from becoming sharply increasing, the braking current that is generated when any of the switching elements S1˜S4 is turned off is reduced. As a result, the switching loss is prevented from becoming large and the high voltage is efficiently generated. On the other hand, when the output voltage Vx is high, the high voltage is generated efficiently by using the voltage boosting effect by the resonant capacitor in the same way as the first comparison example.

In other words, the control device (5) of this embodiment performs a current circulation function of switching on at least one of plural switching elements (S1˜S4) to pass the inverter current Iinv to circulate between the switching circuit (2) and the transformer (3) in such a way that the polarity of the capacitor voltage (VCp2) connected with the secondary winding (N2) is reversed.

Due to this function, the switching loss is prevented from becoming high, which results in the highly efficient high voltage generating device (101) being realized.

To be more specific, the control device (5) performs a power supply function (ML4 and t28˜t29) of switching on both of the switching elements (S1) and (S4) or both of the switching elements (S2) and (S3) to supply power from the direct current power source (1) to the transformer (3) and a current circulation function (ML2 and ML7) of switching on one of the switching elements (S1) and (S4) with the other kept off or switching one of the switching elements (S2) and (S3) with the other kept off.

The control device (5) is capable of continually performing the power supply function and the current circulation function.

In addition, the control device (5) is able to perform the current circulation function (ML2) from a state (ML1) when no current passes through the primary winding (N1) of the transformer (3) while keeping off at least one of the first switching element (S1) and the fourth switching element (S4) or while keeping off at least one of the second switching element (S2) and the third switching element (S3), and subsequently perform the power supply function (ML4)

Accordingly, the current circulation function (ML2) and the power supply function (ML4) can be performed continually in this order from the state (ML1) in which the current passing through the primary winding (N1) of the transformer (3) is zero.

Moreover, the control device (5) is configured to periodically alternate one current circulation function while keeping on one of the switching element (S1) and the switching element (S4) and keeping off the other and the other current circulation function while keeping on one of the switching element (S2) and the switching element (S3) and keeping off the other.

As a result, the conducting loss of each switching element and heat generation of the switching elements are averaged.

Furthermore, it is possible to effectively utilize a stray capacitance between a couple of terminals of the secondary winding (N2) as a resonant capacitor (Cp2) that is a circuit element. This resonant capacitor (Cp2) of the stray capacitance can be charged by a voltage (VCp2) generated over the secondary winding N2.

### Second Embodiment

(Configuration of Second Embodiment)

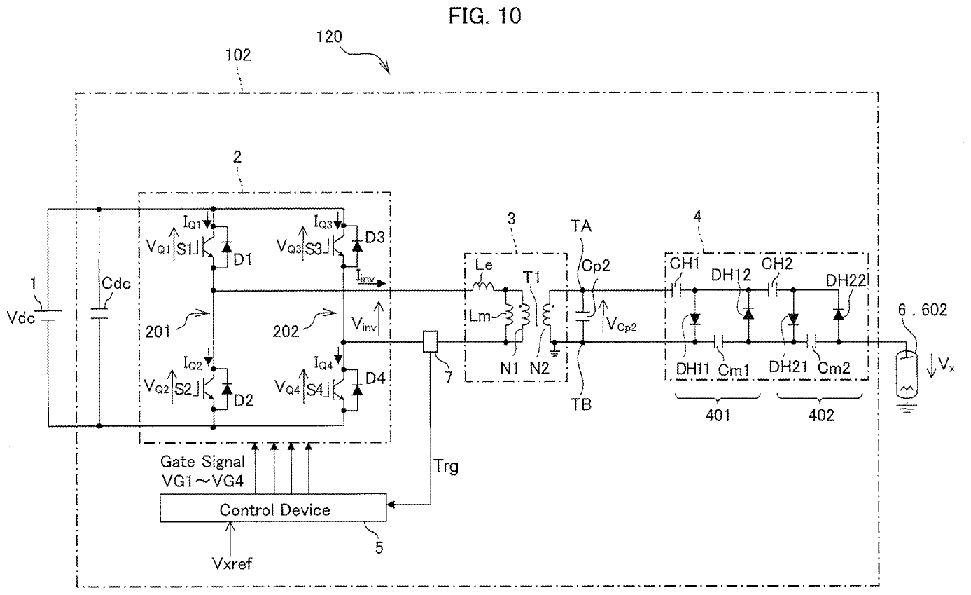

FIG. 10 shows a circuit configuration of an X-ray image diagnosis apparatus 120 of a second embodiment of the present invention. In the description below, the same sign as attached to a part in the first embodiment is attached to the corresponding part in the second embodiment. An explanation already given on the corresponding part in the first embodiment can be skipped in the description below.

The X-ray image diagnosis apparatus 120 comprises a high voltage generating device 102 and an X-ray tube 602 as a load device for the high voltage generating device 102. The high voltage generating device 102 comprises a smoothing capacitor Cdc, a high frequency inverter 2, a transformer 3, a resonant capacitor Cp2, a rectifying circuit 4 and a control device 5. In addition, the high voltage generating device 102 of this embodiment includes a current detection circuit 7 connected between the high frequency inverter 2 and the transformer 3 to measure an inverter current Iinv.

The current detection circuit 7 is configured to output a measurement result of the inverter current Iinv and a trigger signal Trg. The trigger signal Trg is at a high level if the inverter current Iinv is not equal to zero in the current circulation mode and is at a low level in the other cases. The high voltage generating device 102 of this embodiment is capable of detecting timings when the current circulation mode gets started and ends with the current detection circuit 7. As a result, the switching elements can be switched at such appropriate timings as the loss is minimum. The switching loss to be caused by recoveries of the diodes D1˜D4 is reduced, and a risk of any of the elements breaking is further reduced as well.

(Operation of Second Embodiment)

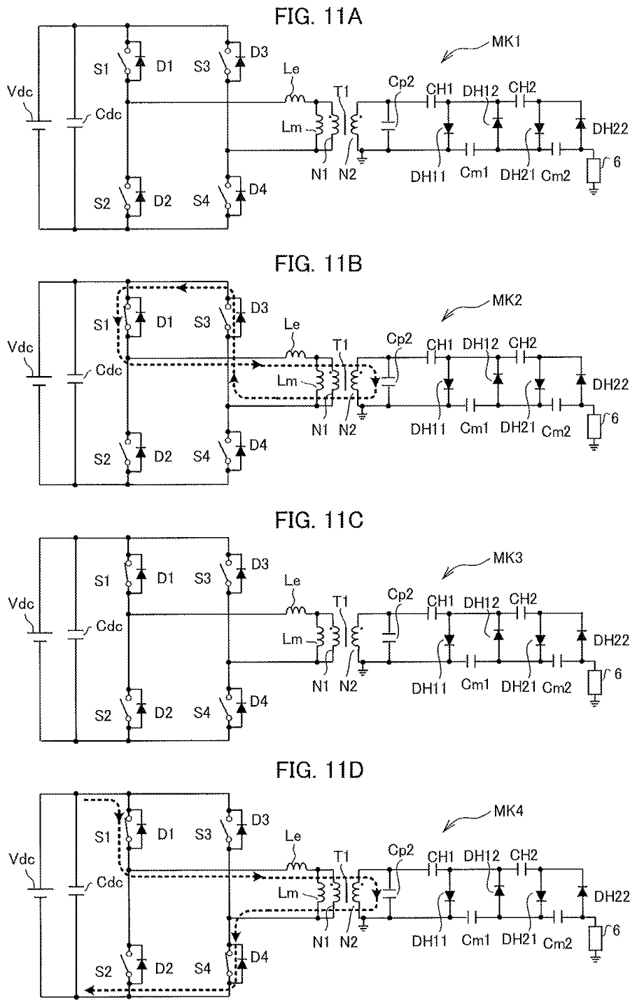

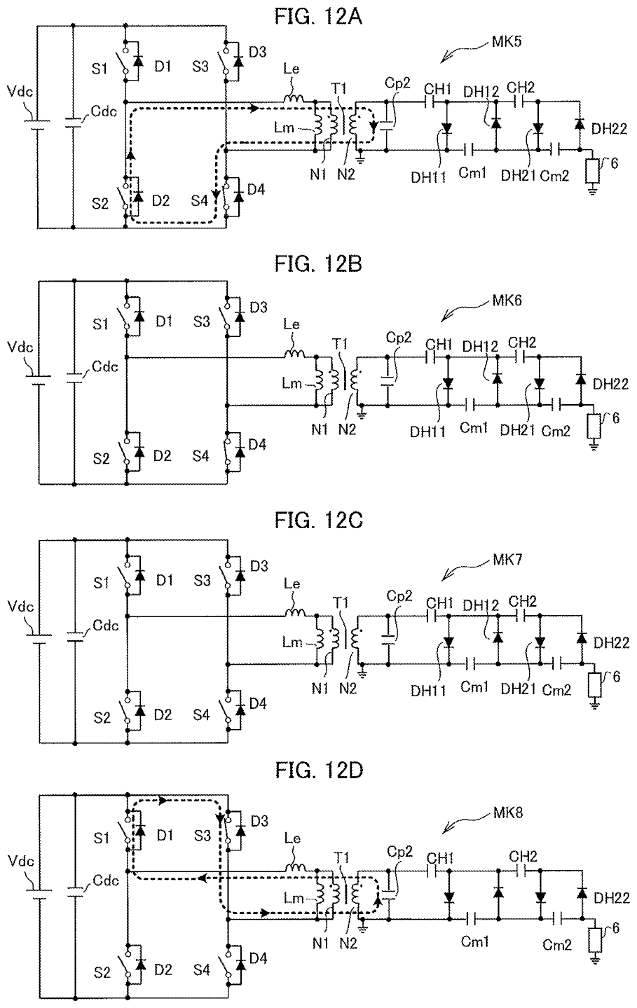

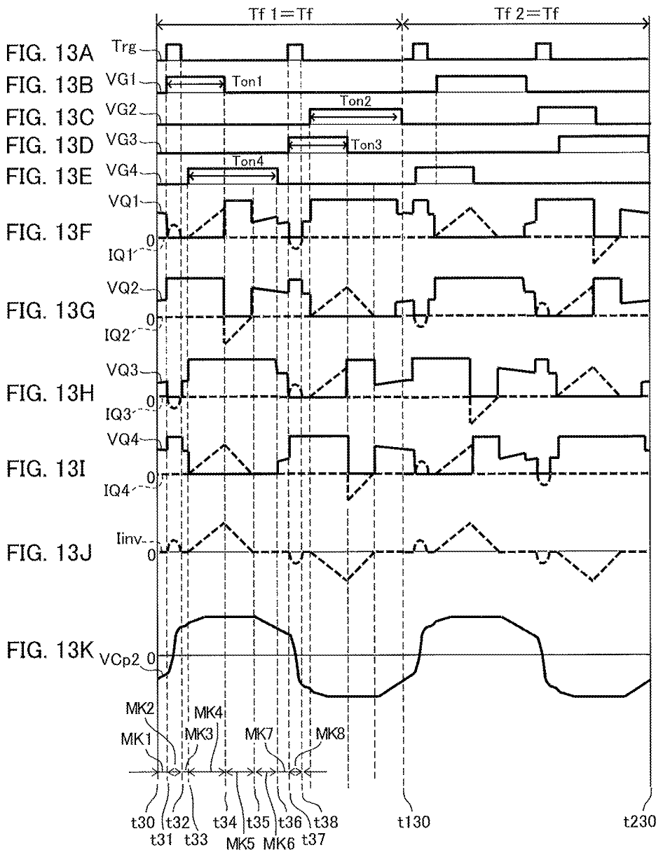

FIGS. 11A to 11D and FIGS. 12A to 12D explain operations of different states in the second embodiment. FIG. 13A to 13K show waveforms of various parts related their operations in the second embodiment. The control device 6 of this embodiment is configured to perform PWM control by switching on switching elements of each of a couple of pairs, one pair of the switching elements S1 and S4 and the other pair of the switching elements S2 and S3. It should be noted that PWM control to be performed in this embodiment is asymmetrical PWM control in which on-periods of the couple of the switching elements of each pair are asymmetrical.

(State MK1: t30˜t31)

In the state MK1 as shown in FIG. 11a, the switching elements S1 to S4 are kept off and no current passes through the high frequency inverter 2. This state MK1 corresponds to a period between Time t20 and Time t31 in FIGS. 13A to 13K. In the state MK1, the resonant capacitor Cp2 (See FIG. 1) is charged with the terminal TB of the secondary winding N2 being on the positive side. The state MK1 transitions to the state MK2 on switching on the switching element S1 in the state MK1.

(State MK2: t31˜t32)

In the state MK2 as shown in FIG. 11B, the switching element S1 is on and the inverter current Iinv passes from the resonant capacitor Cp2 that works as a power source through a path through the diode D3, the switching element S1 and the boosting inductor Le and circulates through this path. Accordingly, the operation in the current circulation mode occurs. When the current detection circuit 7 (See FIG. 10) detects the inverter current Iinv increasing sharply at Time 31, the trigger signal rises to a high level. While the inverter current Iinv is passing to circulate, the resonant capacitor Cp2 charged with the terminal TB of the secondary winding N2 being on the positive side discharges all electrical charges it stores.

Then the resonant capacitor Cp2 is charged again with the terminal TA of the secondary winding being N2 on the positive side. Accordingly, as a waveform of the capacitor voltage VCp2 during a period of Time t31˜Time t32 in FIG. 13k indicates, polarity of the capacitor voltage VCp2 reverses from negative to positive during the period. When the inverter current Iinv becomes zero subsequently, the trigger signal Trg of the current detection circuit 7 lowers sharply to a low level. Then the state MK2 transitions to the state MK3 when the control device 5 (See FIG. 10) detects the trigger signal lowering sharply.

(State MK3: t32˜t33)

In the state MK3 as shown in FIG. 11C, the inverter current Iinv passing through the high frequency inverter is zero with the switching element S1 kept on and with the resonant capacitor charged with the terminal TA of the secondary winding being on the positive side. As a result, the capacitor voltage VCp2 is positive in the state MK3 (Time t32˜Time t33) shown in FIG. 13K. The state MK3 transitions to the state MK4 when a gate signal V4 is increased sharply to switch on the switching element S4. A period of the state MK3 (Time t32˜Time t33) corresponds to a delay time generated inside the control device 5 from a time when the control device 5 detects the trigger signal Trg lowering sharply to a time when the control device 5 gets the gate signal VG4 to increase sharply in response to its detection of the trigger signal Trg lowering sharply.

(State MK4: t33˜t34)

In the state MK4 as shown in FIG. 11D, both the switching elements S1 and S4 are on and the inverter current Iinv is passing through a path through the switching element S1, the boosting inductor Le, the resonant capacitor Cp2 and the switching element S4. This state MK4 corresponds to the state MH3 in the high voltage mode of the first embodiment (and the comparison example) as explained above and the inverter current Iinv is calculated according to Equation 1 as explained above. Since a differential between the power source voltage Vdc and the capacitor voltage VCp2 is applied to the boosting inductor Le like the state MH3 as shown in FIG. 4B, the slope of the inverter current Iinv is more gradual than when only the power source voltage Vdc is applied to the boosting inductor Le. The state MK4 transitions to the state Mk5 on switching off the switching element S1 with the switching element S4 kept on in the state MK4.

(State MK5: t34˜t35)

In the state MK5 as shown in FIG. 12A, only the switching element S4 is on. Then the inverter current Iinv is passing through a path through the switching element S4, the diode D2, the boosting inductor Le and the resonant capacitor Cp2 and energy stored in the boosting inductor Le is transferred to the resonant capacitor Cp2. As a result, the resonant capacitor Cp2 is charged with the terminal TA of the secondary winding N2 being on the positive side. The state MK5 transitions to the state MK6 when the inverter current Iinv becomes zero with the energy stored in the boosting inductor Le becoming zero in the state MK5.

(State MK6: t35˜t36)

In the state MK6, only the switching element S4 out of the switching elements S1 to S4 is on and the inverter current Iinv passing through the high frequency inverter 2 is zero. The resonant capacitor Cp2 is charged with the terminal TA of the secondary winding N2 being on the positive side. Accordingly, the capacitor voltage VCp2 is positive during a period of Time t35˜Time t36, as shown in FIG. 13K. The state MK6 transitions to the state MK7 on switching off the switching element S4 in the state MK6.

(State MK7: t36˜t37)

In the state Mk7 as shown in FIG. 12C, the switching elements S1 to S4 are off and the inverter current Iinv is zero. The state MK7 transitions to the state MK8 on switching on the switching element S3 in the state MK7.

(State MK8: t37˜t38)

In the state MK8 as shown in FIG. 12D, only the switching element S3 is on and the inverter current Iinv is passing from the resonant capacitor Cp2 that works as a power source through a path through the boosting inductor Le, the diode D1 and the switching element S3 and circulates through the path. Accordingly, the operation in the current circulation mode occurs. As the inverter current Iinv is passing to circulate through the path, the resonant capacitor Cp2 charged with the terminal TA of the secondary winding N2 being on the positive side discharge all electrical charges it stores.

Subsequently, the resonant capacitor Cp2 is charged again with the terminal TB of the secondary winding N2 being on the positive side. Accordingly, as a waveform of the capacitor voltage VCp2 during a period of t37˜t38 in FIG. 13K indicates, polarity of the capacitor voltage VCp2 reverses from positive to negative during the period. When the inverter current Iinv becomes zero, the current detection circuit 7 lowers sharply the trigger signal Trg to the low level at Time t38 in FIG. 13A. When the control device 5 (See FIG. 10) detects the trigger signal Trg lowering sharply, the high voltage generating device 102 transitions to a next state.

(After Time t38)

During a period of t38˜t130 as shown in FIG. 13B˜13E, symmetrical operations to the states MK3 MK6 occur, a period Tf1 of Time t30˜Time t130 is equal to a switching cycle Tf. A subsequent period Tf2 of Time t130˜Time t230 corresponds to a next switching cycle Tf. Making a comparison between these periods Tf1, Tf2, on and off timings of each pair of the switching elements are exchanged. During the period Tf2, the gate signal VG4 rises to the high level before the gate signal VG1 does and falls to the low level before the gate signal VG1 does. Similarly, the gate signal VG2 rises to the high level before the gate signal VG3 does and falls to the low level before the gate signal does.

In other words, the switching element that is kept on in the current circulation mode (for example, MK2, MK8) is switched from one of the switching elements to other one of them when a switching cycle advances to the following one. As the switching elements are controlled in this way, the conduction losses and the heat generations among the switching elements can be averaged. Therefore, the breakdown rate of the elements can be made lower for this embodiment than in the case where one of the pair of the switching elements is always kept on in the current circulation mode.

(Effect of Second Embodiment)

When the gate signals VG1 to VG4 used for the examples in FIGS. 7A˜7D are applied, each pair of the switching elements (each of a pair of switching elements S1, S4 and another pair of switching elements S2, S3) are simultaneously turned off and turned on at different timings. However, each pair of the switching elements may be turned on simultaneously and turned off at different timings, which is opposite to the example described in FIGS. 7A˜7D. As described, if such a PWM control that on-periods of each pair of the switching elements are unequal is performed, the switching elements S1 to S4 can be turned off with currents IQ1 to IQ4 passing respectively through the switching elements S1 to S4 being 0 (or close to 0). Therefore, the high voltage generating device of the present embodiment can be more efficient than that of the first embodiment.

In addition, the high voltage generating device 102 of this embodiment includes the current detection circuit (7) to detect the current passing through the primary winding (N1), and the operation timings of the current circulation function and the power supply function are determined based on the detection results of the current detection circuit (7).

As a result, the current circulation function and the power supply function are performed at appropriate timings and the loss is further reduced.

### Third Embodiment

<Configuration of Third Embodiment>

Next, the high voltage generating device of the third embodiment is explained. The circuit configuration of this embodiment is the same as that of the first embodiment (See FIG. 1), and the high voltage generating device is capable of applying any voltage to the load device 6. Parts in this embodiment that correspond to those in the previous embodiments has the same signs thereon and descriptions about some of them are skipped.

This embodiment is intended to apply an intermittent control to drive and stop the high frequency inverter 2 cyclically to achieve high efficiency in a light load region where the output current supplied to the load device 6 is low. The control device 5 applies a predetermined base frequency Fsw_ref when the output current is sufficiently large. When the output current is small, the control device 5 applies a drive frequency Fsw that is lower than the base frequency Fsw_ref to control the output power with the lower drive frequency.

### Second Comparison Example

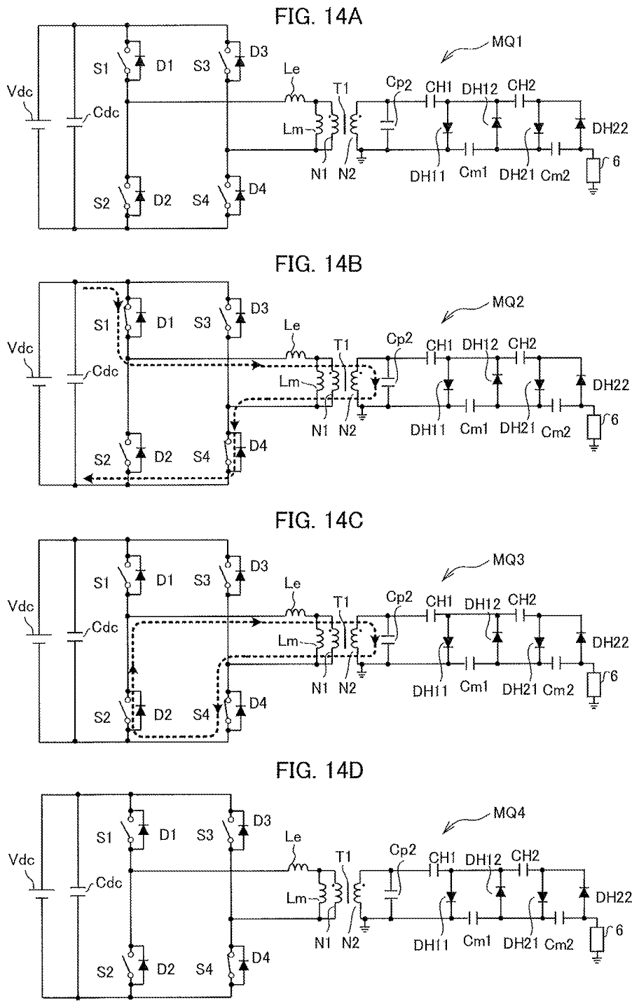

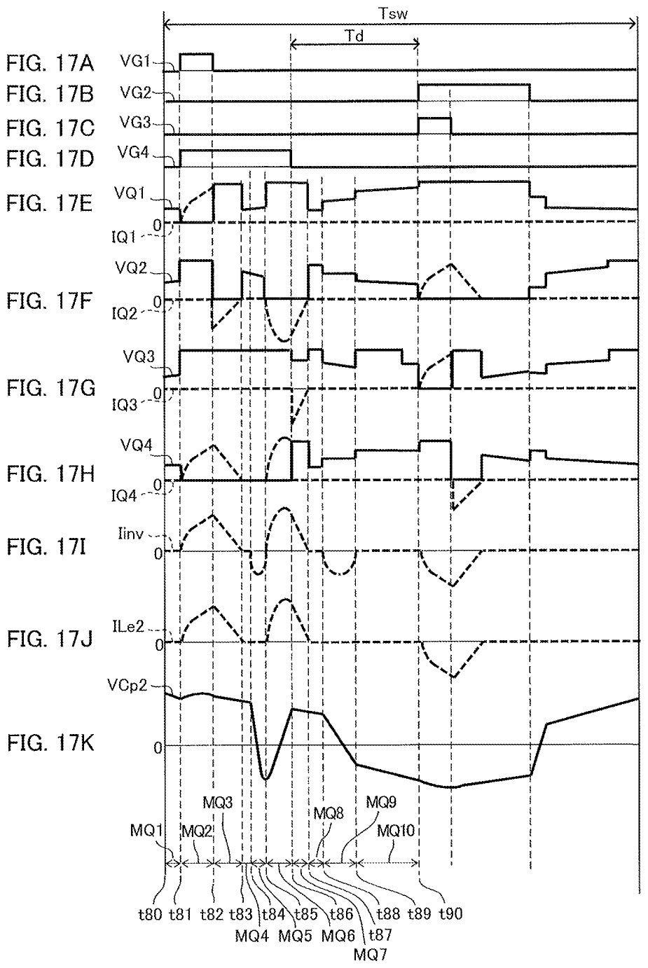

Before explaining operation of this embodiment, the content of a second comparison example in which an intermittent control is performed is explained. A circuit configuration of the second comparison example is similar to those used for the first and second embodiments (See FIG. 1). FIGS. 14A to 14D, FIGS. 15A to 15D and FIGS. 16A to 16B show operations in various states of this comparison example. FIGS. 17A to 17K show waveforms of various parts in the second comparison example. A current ILe2 in FIG. 17J indicates a current passing through the secondary winding N2. The following describes an example in which the drive frequency of the high frequency inverter 2 is set to more or less a half the base frequency Fsw_ref.

(State MQ1: t80˜t81)

In a state MQ1 as shown in FIG. 14A, the switching elements S1 to S4 are off and no current is passing through the high frequency inverter 2. This state MQ1 corresponds to a period of Time t80˜Time t81 in FIGS. 17A to 17K. In the state MQ1, the resonant capacitor Cp2 (See FIG. 1) is charged with the terminal TA of the secondary winding N2 being on the positive side. The state MQ1 transitions to a state MQ2 on switching elements S1 and S4 in the state MQ1.

(State MQ2: t81˜t82)

In the state MQ2 as shown in FIG. 14B, an inverter current Iinv is passing through a path through the switching element S1, the boosting inductor Le, the resonant capacitor Cp2 and the switching element S4 with the switching elements S1 and S4 kept on. In this state, the capacitor voltage VCp2 over the resonant capacitor Cp2 has polarity with the terminal TA of the secondary winding N2 being on the positive side. The state MQ2 transitions to a state MQ3 on switching off the switching element S1 in the state MQ2.

(State MQ3: t82˜t83)

In the state MQ3 as shown in FIG. 14C, only the switching element S4 is on. Then the inverter current Iinv is passing through a path through the switching element S4, the diode D2, the boosting inductor Le and the resonant capacitor Cp2 and energy stored in the boosting capacitor Le is transferred to the resonant capacitor Cp2. The resonant capacitor Cp2 is charged with the terminal TA of the secondary winding N2 being on the positive side. When the energy stored in the boosting inductor Le becomes zero in the state MQ3, the state MQ3 transitions to a state MQ4.

(State MQ4: t83˜t84)

In the state MQ4 as shown in FIG. 14D, the inverter current Iinv passing through the high frequency inverter 2 is zero with only the switching element S4 kept on out of the switching elements S1 to S4. The resonant capacitor Cp2 is charged with the terminal TA of the secondary winding N2 being on the positive side. Accordingly, the capacitor voltage VCp2 is positive as shown in FIG. 17K in the state MQ4 (Time t83˜Time t84). When a voltage-time product of the voltage applied to the transformer 3 (See FIG. 1) multiplied by a time becomes a predetermined value in the state MQ4 (Time t83˜Time t84), the state MQ4 transitions to a state MQ5.

(State MQ5: t84˜t85)

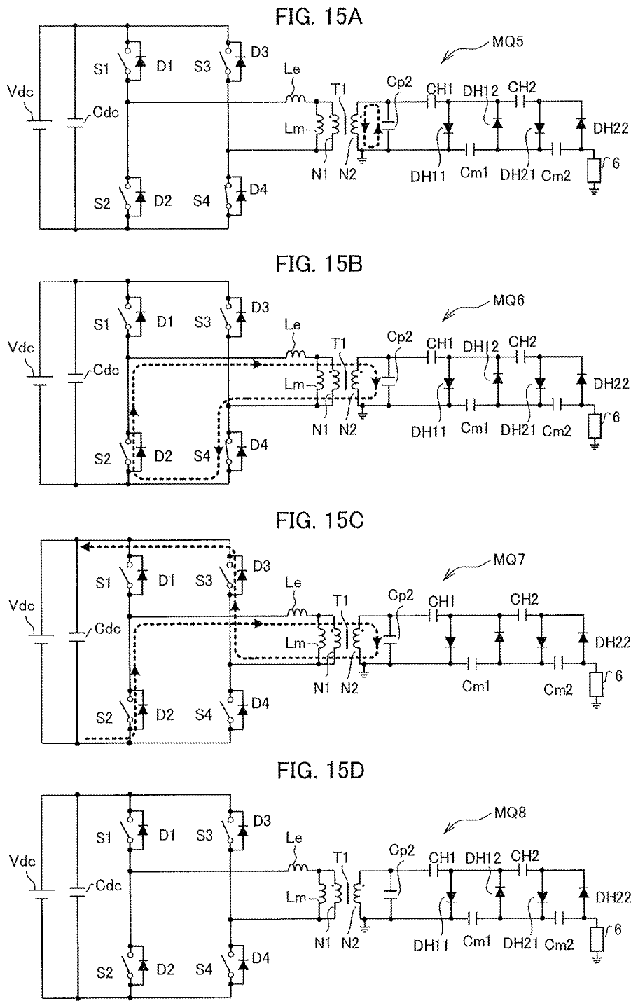

In the state MQ5 as shown in FIG. 15A, only the switching element S4 out of the switching elements S1 to S4 is on and no inverter current Iinv is passing through the high frequency inverter 2. However, since an exciting inductance Lm of the transformer 3 sharply decreases due to the magnetic saturation, a resonance current, which depends on an inductance of the transformer 3 and a capacitance of the resonant capacitor Cp2, passes through the secondary winding N2. After the resonant capacitor Cp2 discharges electrical charges it stores, the resonant capacitor Cp2 is charged again with the terminal TB of the secondary winding N2 being on the positive side. As a result, as a waveform of the capacitor voltage VCp2 during a period of Time t84˜Time t85 in FIG. 17K indicates, polarity of the capacitor voltage VCp2 reverses from positive to negative during the period. When the resonant capacitor Cp2 is fully charged with the terminal TB being on the positive side, the state MQ5 transitions to a state MQ6.

(State MQ6: t85˜t86)

In the state MQ6 as shown in FIG. 15B, operations of the resonant capacitor Cp2 being charged and discharged occur with only the switching element S4 kept on out of the switching elements S1 to S4. Accordingly, the inverter current Iinv passes from the resonant capacitor Cp2 that works as a power source through a path through the switching element S4, the diode D2 and the boosting inductor Le and circulates through this path. The state MQ6 transitions to a state MQ7 on switching off the switching element S4 in the state MQ6.

(State MQ7: t86˜t87)

In the state MQ7 as shown in FIG. 15C, the switching elements S1 to S4 are off and the inverter current Iinv is passing through a path through the diode D2, the boosting inductor Le, the resonant capacitor Cp2 and the diode D3. When the energy stored in the boosting inductor Le becomes zero in the state MQ7, the inverter current becomes zero as well and the state MQ7 transitions to a state MQ8.

(State MQ8: t87˜t88)

In the state MQ8 as shown in FIG. 15D, the switching elements S1 to S4 are off and the inverter current passing through the high frequency inverter 2 is zero. The resonant capacitor Cp2 is charged with the terminal TA of the secondary winding N2 being on the positive side. Accordingly, as shown in FIG. 17K, the capacitor voltage VCp2 is positive in the state MQ8 (Time t87˜Time t88). When the transformer 3 (See FIG. 1) has magnetic saturation in the state MQ8, the state MQ8 transitions to a state MQ9.

(State MQ9: t88˜t89)

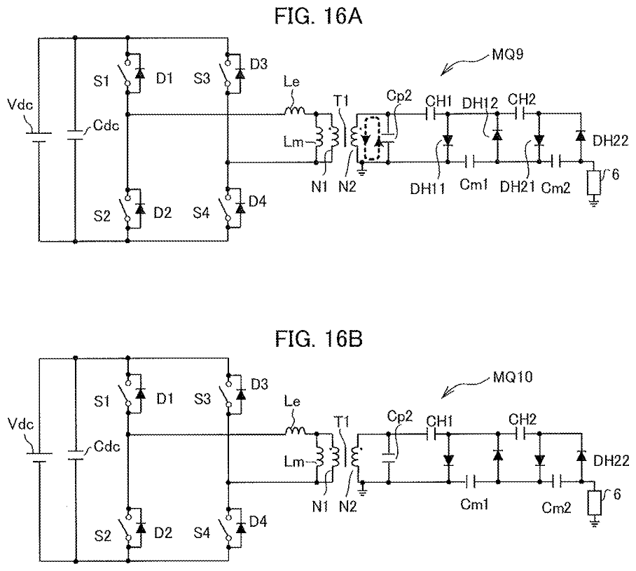

In the state MQ9 as shown in FIG. 16A, the switching elements S1 to S4 are off and the inverter current passing through the high frequency inverter 2 is zero. However, since the exciting inductance of the transformer 3 decreases sharply due to the magnetic saturation, a resonance current, which depends on the inductance of the transformer 3 and the capacitance of the resonant capacitor Cp2, passes through the secondary winding N2. The resonant capacitor Cp2 is discharged once and then charged again with the terminal TB of the transformer 3 being on the positive side. Accordingly, as a waveform of the capacitor voltage VCp2 during a period of Time t88˜Time t89 in FIG. 17K indicates, polarity of the capacitor voltage VCp2 reverses from positive to negative during the period. When the resonant capacitor Cp2 is fully charged with the terminal TB of the secondary winding N2 being on the positive side, the state MQ9 transitions to a state MQ10.

(State MQ10: t89˜t90)

In the state MQ10 as shown in FIG. 16B, the switching elements S1 to S4 are off and the inverter current passing through the high frequency inverter 2 is zero. In the state MQ10, the resonant capacitor Cp2 is fully charged with the terminal TB of the secondary winding N2 being on the positive side. The state MQ10 transitions to a next state on switching on the switching elements S2 and S3 in the state MQ10.

(After Time t90)

As indicated in FIGS. 17A to 17K, symmetrical operations to those occurring in the states MQ2˜MQ10 occur after Time t90 when the state MQ10 ends. A drive cycle Tsw as indicated in FIGS. 17A to 17K corresponds to an inverse of the drive frequency Fsw above mentioned. A dead time period Td is a period during which no power is supplied to the transformer 3 (See FIG. 1) from the high frequency inverter 2. When the intermittent control is applied like the example as shown in FIGS. 17A to 17K, the output control is carried out mainly through changing timings of the states MQ1˜MQ4 and the state MQ10 to change the dead time Td. In the circuit configuration in which the secondary winding N2 and the resonant capacitor Cp2 are connected in parallel with each other like the device of the second comparison example, the transformer 3 is excited with the capacitor voltage VCp2 applied to the resonant capacitor Cp2 even during the dead time period Td.

However, according to the configuration of the second comparison example, an extremely high current could pass through the transformer 3 due to the magnetic saturation of the transformer 3, if timings at which the switching elements S1˜S4 are switched are inappropriate. Since the magnetic saturation of the transformer 3 occurs when some of such factors as the number of turns of the transformer 3, the property of a core of the transformer 3 and the load are combined, it is difficult to predict when the magnetic saturation occurs. If the magnetic flux density is decreased by increasing the number of turns of the transformer 3, the magnetic saturation of the transformer 3 can be prevented. However, there is another problem with the transformer 3 becoming larger in this case.

(Operation of Third Embodiment)

(Control Program)

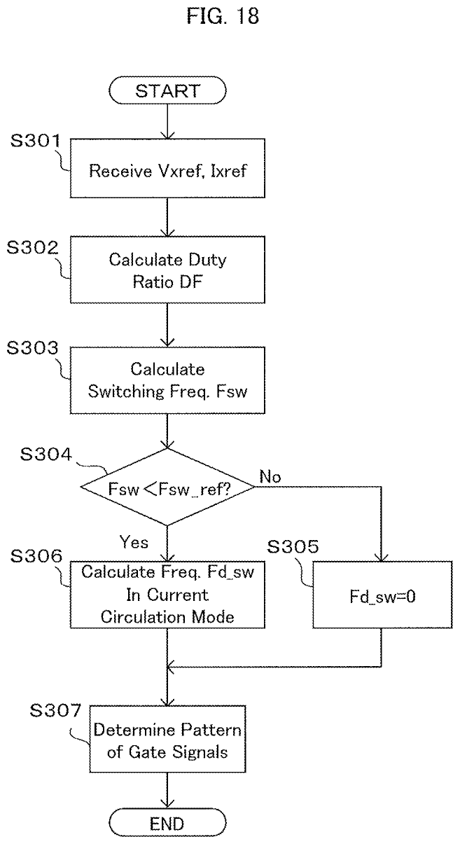

Next, operation of the third embodiment is explained. FIG. 18 is a flowchart for the control program to be executed on the control device 5 of this embodiment.

When the processing gets started in FIG. 18, the control device 5 (See FIG. 1) receives an output voltage instruction value Vxref and an output current instruction value Ixref from its superordinate device (not shown) in Step 301. The output current instruction value Ixref is an instruction value for a current to pass through the load device 6.

When the processing goes to Step 302, the control device 5 calculates a duty ratio DF based on the output voltage instruction value Vxref, the output current instruction value Ixref, an output voltage Vx and an output current Ix.

Next, when the processing goes to Step 303, the control device 5 calculates a drive frequency Fsw of the high frequency inverter 2 based on the calculated duty ratio DF. For instance, comparing the calculated duty ratio DF with a predetermined threshold value DFth, the control device 5 may set the drive frequency Fsw to a base frequency Fsw_ref if the duty ratio DF is larger than or equal to the threshold value DFth. On the other hand, if the duty ratio DF is smaller than the threshold value DFth, the control device 5 may set the drive frequency Fsw to a smaller value than the base frequency Fsw_ref.

Next, when the processing goes to Step 304, the control device 5 determines whether the drive frequency Fsw is lower than the above described base frequency Fsw_ref above mentioned or not. In Step 304, if the determination result is “No” (Fsw≥Fsw_ref), the processing goes to Step 305, in which the control device 5 sets a current circulation mode frequency Fd_sw to zero. The current circulation mode frequency Fd_sw is a frequency at which the inverter current Iinv of the high frequency inverter 2 passes to circulate. The current circulation mode frequency Fd_sw being zero means that the intermittent control is not carried out (for example, the operation that is the same as the first embodiment is carried out).

On the other hand, if the determination result is “Yes” (Fsw<Fsw_ref) in Step 304, the processing goes to Step 306 and the control device 5 calculates the current circulation mode frequency Fd_sw based on the following Equations 3˜5.

α=Fsw_ref/Fsw Equation 3

Td_sw=(1/Fsw−1/Fsw_ref)/2 Equation 4

Fd_sw=1/(Td_sw/A) Equation 5

In these Equations, according to “Fsw<Fsw_ref”, the value α in Equation 3 is a real number larger than or equal to 1. Accordingly, a natural number N that is larger than or equal to 2 and meets “N−1<α≤N” is uniquely obtained. An alternation number A in equation 5 is a natural number larger than or equal to 1 and obtained by “A=N−1”.

When Step 305 or Step 306 is finished, the processing goes to Step 307. In Step 307, the control device 5 determines a pattern of the gate signals VG1˜VG4 to drive the switching elements S1˜S4 based on the drive frequency Fsw, the duty ratio DF and the current circulation mode frequency Fd_sw. Then the processing of this program ends. The control device 5 repeatedly outputs the gate signals VG1˜VG4 according to the pattern determined in Step 307.

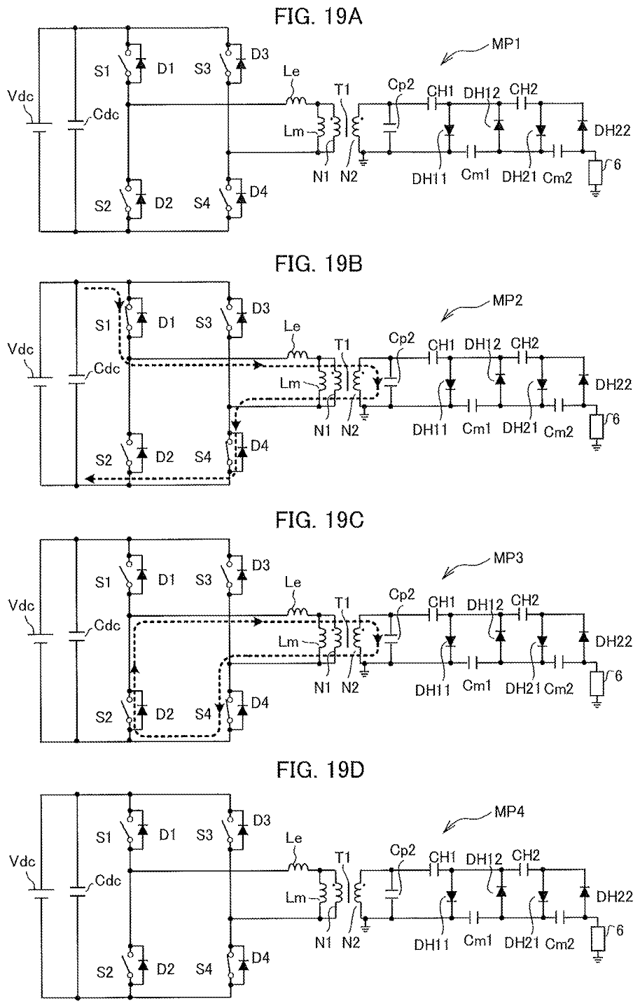

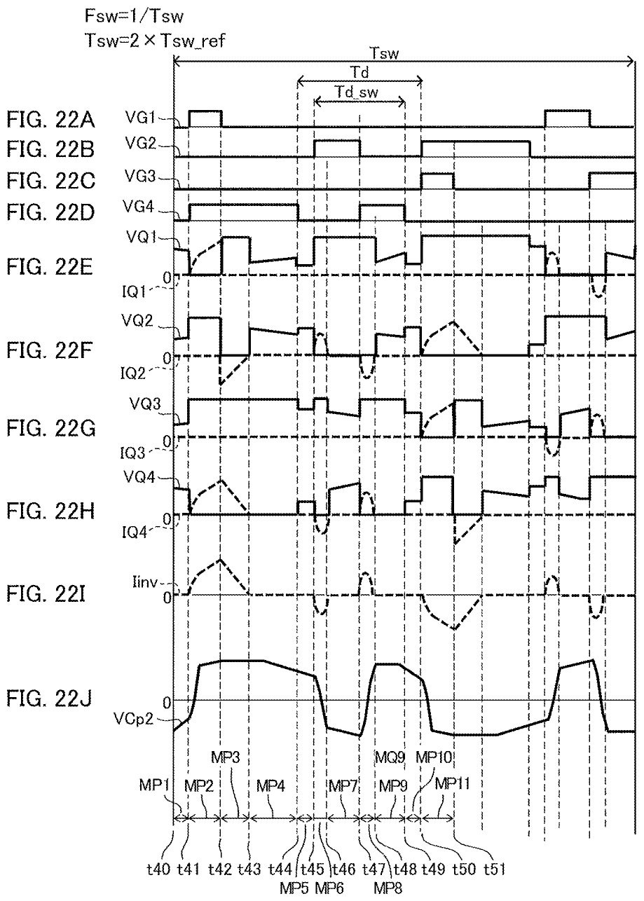

FIGS. 19A to 19D, FIGS. 20A to 20D and FIGS. 21A to 21C explain operation in each of states of the third embodiment in which the current circulation mode frequency Fd_sw is not zero. It should be noted that a waveform of each of the parts is the same as that of the first embodiment. FIG. 22A to 22J show waveforms of various parts in the third embodiment. An example shown in these figures corresponds to an example in which the drive frequency Fsw of the high frequency inverter 2 is set to more or less half the frequency of the base frequency Fsw_ref.

(State MP1: t40˜t41)

In a state MP1 as shown in FIG. 19A, the switching elements S1 to S4 are off and no current is passing through the high frequency inverter 2. In this state, the resonant capacitor Cp2 is charged with the terminal TB (See FIG. 1) of the secondary winding N2 being on the positive side. The state MP1 transitions to a state MP2 on switching on the switching elements S1 and S4 simultaneously in the state MP1.

(State MP2: t41˜t42)

In the state MP2 as shown in FIG. 19B, a current is passing through a path through the switching element S1, the boosting inductor Le, the resonant capacitor Cp2 and the switching element S4. The state MP2 transitions to a state MP3 on switching off the switching element S1 in the state MP2.

(State MP3: t42˜t43)

In the state MP3 as shown in FIG. 19C, a current is passing through a path through the diode D2, the boosting inductor Le, the resonant capacitor Cp2 and the switching element S4 and circulates through this path. While this current is passing in the state MP3, the capacitor voltage VCp2 over the resonant capacitor Cp2 has polarity with the terminal TA of the secondary winding N2 being on the positive side. The state MP3 transitions to a state MP4 when energy stored in the boosting inductor Le becomes zero.

(State MP4: t43˜t44)

In the state MP4 as shown in FIG. 19D, only the switching element S4 continues to be on and no current is passing through the high frequency inverter 2. The capacitor voltage VCp2 over the resonant capacitor Cp2 has polarity with the terminal TA of the secondary winding N2 being on the positive side. The state MP4 transitions to a state MP5 on switching off the switching element S4 in the state MP4.

(State MP5: t44˜t45)

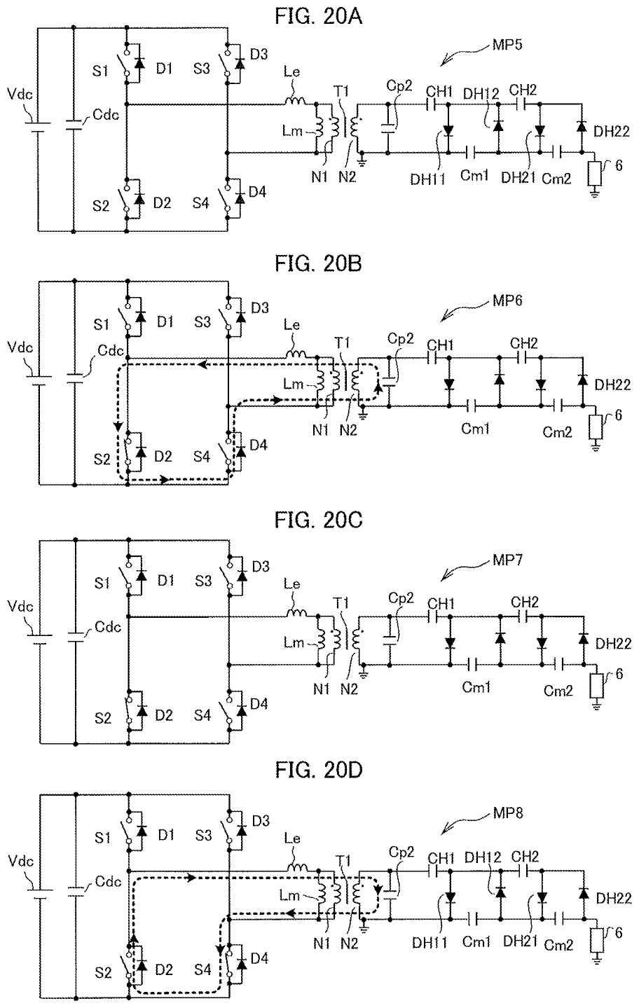

In the state MP5 as shown in FIG. 20A, the switching elements S1 to S4 are off and no current is passing through the high frequency inverter 2. In this state, the capacitor voltage VCp2 over the resonant capacitor Cp2 has polarity with the terminal TA of the secondary winding being on the positive side. The state MP5 transitions to a state MP6 on switching on the switching element S2 in the state MP5.

(State MP6: t45˜t46)

In the state MP6 as shown in FIG. 20B, only the switching element S2 is on and a current is passing from the resonant capacitor Cp2 that works as a power source through a path through the diode D4, the resonant capacitor Cp2, the boosting inductor Le and the switching element S2 in this order and circulates through this path. Accordingly, an operation in the current circulation mode occurs. While this current is passing, the resonant capacitor Cp2 discharges electrical charges it stores once and is charged again with the terminal TB of the secondary winding N2 being on the positive side. As a result, the polarity of the capacitor voltage VCp2 reverses from positive to negative during a period of Time t45˜Time t46, as indicated by a waveform of the capacitor voltage VCp2 during the period in FIG. 22J. The state MP6 transitions to a state MP7 when the resonant capacitor Cp2 is fully charged with the terminal TB being on the positive side.

(State MP7: t46˜t47)

In the state MP7 as shown in FIG. 20C, the switching element S2 continues to be on and no current is passing through the high frequency inverter 2. In this state, the resonant capacitor Cp2 continues to be charged with the terminal TB of the secondary winding N2 being on the positive side from the state MP6. The state MP7 transitions to a state MP8 on switching off the switching element S2 and simultaneously switching on the switching element S4 in the state MP7.

(State MP8: t47˜t48)

In the state MP8 as shown in FIG. 20D, the switching element S4 is on and a current is passing from the resonant capacitor Cp2 that works as a power source through a path through the diode 2, the boosting inductor Le, the resonant capacitor Cp2 and the switching element S4 and circulates through this path. Accordingly, an operation in the current circulation mode occurs. In this state, the resonant capacitor Cp2 discharges electrical charges it stores once and is charged again with the terminal TA of the secondary winding N2 being on the positive side. As a result, polarity of the capacitor voltage VCp2 reverses from negative to positive during a period of Time t47˜Time t48, as a waveform of the capacitor voltage VCp2 during the period in FIG. 22J indicates. The state MP8 transitions to a state MP9 when the resonant capacitor Cp2 is fully charged with the terminal TA being on the positive side.

(State MP9: t48˜t49)

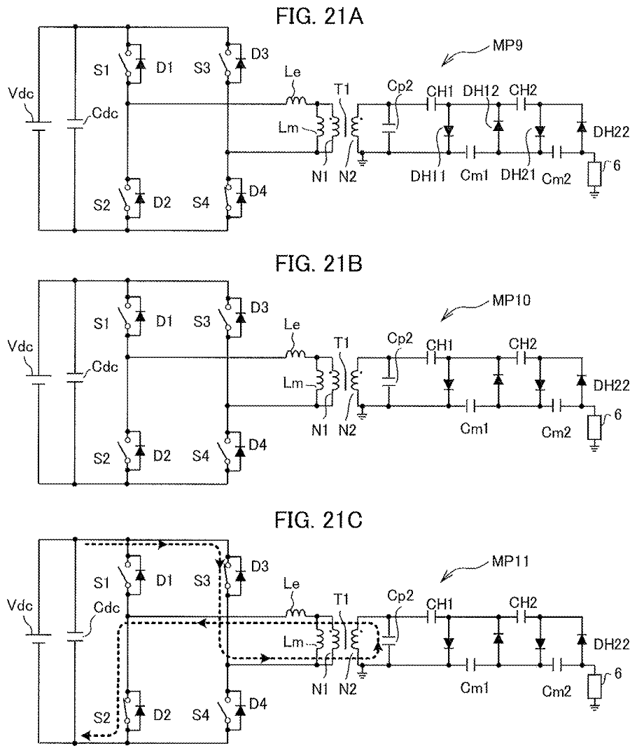

In the state MP9 as shown in FIG. 21A, only the switching element S4 continues to be on and no current is passing through the high frequency inverter 2. In this state, the resonant capacitor Cp2 remains charged with the terminal TA of the secondary winding N2 being on the positive side. The state MP9 transitions to a state MP10 on switching off the switching element S4 in the state MP9.

(State MP10: t49˜t50)

In the state MP10 as shown in FIG. 21B, the switching elements S1 to S4 are off and no current is passing through the high frequency inverter 2. The state MP10 transitions to a state MP11 on switching on the switching elements S2 and S3 simultaneously in the state MP10.

(State MP11: t50˜t51)

In the state MP11 as shown in FIG. 21C, a symmetrical operation to that in the state MP2 takes place. Accordingly, a current is passing through a path through the switching element S3, the resonant capacitor Cp2, the boosting inductor Le and the switching element S2 with the switching elements S2 and S3 kept on. The state MP11 transitions to a next state on switching off the switching element S3 in the state MP11.

(After Time t51)

During a period after Time t51 in FIGS. 22A to 22J, symmetrical operations to those in the states MP4˜MP9 take place. Then the operations in the states MP1˜MP9 or symmetrical operations to them are repeated.

According to this embodiment, the intermittent control has an operation in a current circulation mode (States M6, MP8) in the dead time period and polarity of the capacitor voltage VCp2 is reversed in the current circulation mode, which contributes to preventing too high a current caused by magnetic saturation from passing through the high frequency inverter 2 and reducing the conduction loss and the switching loss to make the high voltage generating device highly efficient.

A period of the states MP6˜MP9 in FIGS. 22A to 22J corresponds a current circulation mode period Td_sw in Equation 4. This embodiment enables setting a current circulation mode frequency Fd_sw (and the current circulation mode period Td_sw) to a value that is appropriate to a length of the dead time period Td, as indicated by Equation 5.

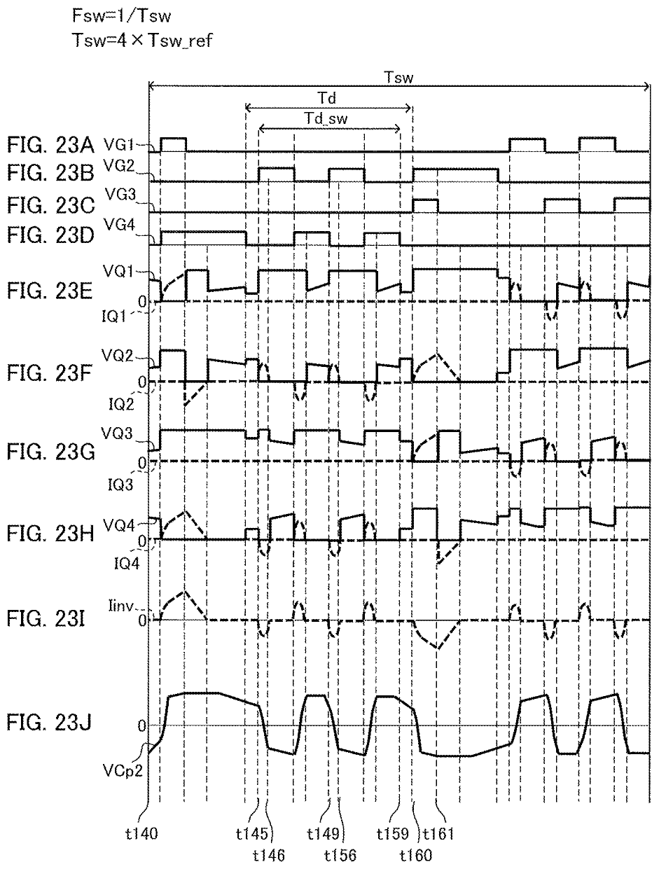

FIGS. 23A to 23J are diagrams showing other waveforms of the third embodiment. This example as shown in these figures corresponds to an example in which the drive frequency Fsw of the high frequency inverter 2 is set to more or less one fourth of the base frequency Fsw_ref. In this case, the alternation number A in Equation 5 is 2.

Each of the waveforms during a period of Time t140˜Time t149 in FIGS. 23A to 23J is the same as the corresponding one of the waveforms during the period of Time t40˜Time t49 in FIGS. 22A to 22D. Each of the waveforms during a period of Time t156˜Time t159 in FIGS. 23A to 23J is the same as the corresponding one of the waveforms during the period of Time t146˜Time t149 in FIGS. 23A to 23D. In addition, each of the waveforms during a period of Time t159˜Time t161 in FIGS. 23A to 23J is the same as the corresponding one of the waveforms during the period of Time t49˜Time t51 in FIGS. 22A to 22D. Accordingly, in this example, each of the gate signals VG2, VG4 rises twice within a current circulation mode period Td_sw of Time 1145˜Time t159. As a result, the polarity of the capacitor voltage VCp2 reverses four times within the current circulation mode period Td_sw.

As has been explained, this embodiment enables setting the current circulation mode period Td_sw, the alternation number A and the current circulation mode frequency Fd_sw to values that are appropriate to the length of the dead time period Td, which enables driving the high frequency inverter 2 at any frequency while preventing the magnetic saturation of the transformer 3.

(Effect of Third Embodiment)

The control device (5) of the third embodiment has a first current circulation function (MP6) in which a current is passing to circulate while keeping on one of the first switching element (S1) and the fourth switching element (S4) and keeping off the other or while keeping on one of the second switching element (S2) and the third switching element (S3) and keeping off the other and a second current circulation function (MP8) in which a current is passing to circulate while keeping the first switching element (S1) and the fourth switching element (S4) in reversed on-and-off states from the first current circulation function or while keeping the second switching element (S2) and the third switching element (S3) in reversed on-and-off states from the first current circulation function, and the control device (5) alternates the first current circulation function (MP6) and the second current circulation function (MP8).

As a result, this embodiment enables driving the switching circuit (2) at a frequency in a wide frequency range while preventing the magnetic saturation of the transformer (3).

### Modification

The present invention should not be limited to the embodiments above explained and various modifications are possible. The embodiments above explained are intended to explain the present invention so that the present invention is easily understood and exemplify examples and the present invention should not be limited to such an invention as to include all elements of any embodiment described. It is possible to replace an element in one embodiment with another element in other embodiment. It is also possible to add an element in one embodiment to an element in another embodiment. It is further possible to remove an element in one embodiment or replace or add another element in other embodiment. Control lines and information lines shown in the figures are considered to be necessary for the explanation and all control lines and information lines are not necessarily needed for an actual product. In actuality, all elements may be interconnected with one another. The following examples are possible modifications from the embodiments above described.

(1) In the example as shown in FIGS. 7A to 7D˜FIGS. 9A to 9J, the switching element S1 is on in the state ML2 and the switching element S3 is on in the state ML7. In this example, the switching element S4 may be on instead in the state ML2 and the switching element S2 may be on instead in the state ML7.

(2) In each of the embodiments above described, Cockcroft-Walton circuit is used as the rectifying circuit 4. Other types may be used. For example, the rectifying circuit may be symmetrical Cockcroft-Walton circuit, full-wave rectifying circuit or voltage doubler rectifying circuit.

(3) In each embodiment above described, only one switching element out of the four switching elements S1 to S4 is on in the current circulation mode (for example, in the state as shown in FIG. 7B and in the state ML7 as shown in FIG. 8C). When either of the switching elements S1 and S3 of the upper arm is switched on, both switching elements S1 and S3 may be switched on. Similarly, either of the switching elements 32 and S4 of the lower arm is switched on, both switching elements S2 and S4 may be switched on.

(4) Since the control device 6 in the embodiments above described is realized with a general-purpose computer, programs for the flowcharts described in FIG. 6 and FIG. 18 may be stored in a storage medium and sent to the computer through a transmit line.

(5) Although the processes described in FIG. 6 and FIG. 18 are described as software processing using a program, part or the whole of each process may be a hardware process performed with ASIC (Application Specific Integrated Circuit) or FPGA (Field Programmable Gate Array).

(6) The high voltage generating devices 101, 102 in the embodiments above described may be applied not only to the X-ray image diagnosis apparatus in the second embodiment, but also to a communication device, an industrial apparatus or other various electrical apparatus. The apparatus to which this high voltage generating device is applied can have an improved performance suited for its usage.

1. A high voltage generating device comprising;
a switching circuit comprising plural switching elements and connected with a direct current power source;
a rectifying circuit;
a transformer comprising a primary winding connected with the switching circuit and a secondary winding connected with the rectifying circuit and
a control device controlling the switching circuit,
wherein the control device configured to control the switching circuit in such a way that a current passes to circulate between the switching circuit and the transformer so as to reverse polarity of a voltage over the secondary winding, while keeping on at least one of the plural switching elements.

2. The high voltage generating device as described in claim 1,
wherein the switching circuit comprises a first switching element and a second switching element that are connected in series with the direct current power source and a third switching element and a fourth switching element that are connected in series with the direct current power source, and
wherein the control device is configured to perform a power supply function of supplying power to the transformer by keeping on both the first switching element and the fourth switching element or by keeping on both the second switching element and the third switching element and perform a current circulation function of passing a current to circulate between the switching circuit and the transformer by keeping on one of the first switching element and the fourth switching element and keeping off the other or by keeping on one of the second switching element and the third switching element and keeping off the other.

3. The high voltage generating device as described in claim 2,
wherein the control device alternates a first current circulation function and a second current circulation function, the first current circulation function to pass a current to circulate between the switching circuit and the transformer by keeping on one of the first switching element and the fourth switching element and keeping off the other or by keeping on one of the second switching element and the third switching element and keeping off the other, and the second current circulation function to pass a current to circulate between the switching circuit and the transformer by keeping the first switching element and the fourth switching element in reversed on-and-off states from the first current circulation function or by keeping the second switching element and the third switching element in reversed on-and-off states from the first current circulation function.

4. The high voltage generating device as described in claim 2,
wherein the control device performs the current circulation function either by keeping on both the first switching element and the third switching element or by keeping on both the second switching element and the fourth switching element.

5. The high voltage generating device as described in claim 2,
wherein the control device starts to perform the current circulation function from a state in which a current passing through the primary winding of the transformer is zero with at least one of the first switching element and the fourth switching element are kept off or with at least one of the second switching element and the third switching element kept off, and to subsequently perform the power supply function.

6. The high voltage generating device as described in claim 2, further comprising a current detection circuit to detect a current passing through the primary winding, wherein a timing to perform the current circulation function or the power supply function is determined based a detection result of the current detection circuit.

7. The high voltage generating device as described in claim 2,
wherein the control device controls the switching circuit to periodically alternate a third current circulation function and a fourth current circulation function, the third current circulation function to be performed by keeping on one of the first switching element and the fourth switching element and keeping off the other, the fourth current circulation function to be performed by keeping on one of the second switching element and the third switching element and keeping off the other.

8. The high voltage generating device as described in claim 1,
wherein a stray capacitance between a couple of terminals of the secondary winding is used as a resonant capacitor that is to be charged by a voltage over the secondary winding.

9. An X-ray image diagnosis apparatus comprising;
an X-ray tube to radiate X-ray and
the high voltage generating devise as described in claim 1 to output an output voltage to be applied to the X-ray tube.
